(19) United States
(12) Patent Application Publication
(10) Pub. No.: US 2018/0240123 A1
(43) Pub. Date: Aug. 23, 2018

(54) Payment Processing Method and Apparatus, and Transaction Method and Mobile Device

(71) Applicant: Alibaba Group Holding Limited, Grand Cayman (KY)

(72) Inventors: Yukang Jin, Hangzhou (CN); Aiqing Chen, Hangzhou (CN); Wenhua Gong, Hangzhou (CN); Hanbin Xu, Hangzhou (CN)

(21) Appl. No.: 15/901,672

(22) Filed: Feb. 21, 2018

(30) Foreign Application Priority Data
Feb. 22, 2017 (CN) 201710097256.2

(51) Int. Cl. G06Q 20/40; G06Q 20/32

(52) U.S. Cl. CPC G06Q 20/40145; G06Q 20/3274; G06Q 20/322

(57) ABSTRACT

A method and an apparatus of payment processing, a transaction method and a mobile device are disclosed. The payment processing method includes collecting an audio signal; obtaining a graphic code, wherein the graphic code is generated based on a predetermined account and a number recognized from the audio signal, the number being used for indicating an amount to be paid and the predetermined account being an account that is to have a payment activity; and displaying the graphic code, wherein the graphic code is used for triggering the payment activity with the predetermined account to complete a payment of the amount corresponding to the number upon being scanned. The present disclosure solves the technical problems of a relatively low efficiency of offline transaction processes caused by the need of manual entry of a payment account for each offline payment.

### CROSS REFERENCE TO RELATED PATENT APPLICATIONS

This application claims foreign priority to Chinese Patent Application No. 201710097256.2, filed on Feb. 22, 2017, entitled “Payment Processing Method and Apparatus, and Transaction Method and Mobile Device,” which is hereby incorporated by reference in its entirety.

### TECHNICAL FIELD

The present disclosure relates to the field of payment, and particularly to payment processing methods and apparatuses, and transaction methods and mobile devices.

### BACKGROUND

Along with the development of technology, mobile devices have become increasingly popular in daily lives. People have gradually more frequently used offline payment of application programs in mobile devices. For example, when settlement a bill in supermarket shopping, a payment is made through Alipay in a mobile device. A number of existing offline payments are implemented by scanning graphic codes to make transfers to merchants. In this process, a merchant provides a graphic code that carries account information. After a buyer scans the graphic code, the buyer enters a payment amount, and confirms a transfer by a click to complete a payment to the merchant. Alternatively, the merchant manually enters an amount that the buyer is going to pay to the merchant, and generates a corresponding graphic code. The buyer scans the graphic code of the merchant, and clicks to confirm a transfer to complete the payment to the merchant. Therefore, each offline payment needs a buyer or merchant to manually enter a payment amount, thus affecting the efficiency of an offline transaction process. Furthermore, since a buyer enters an amount paid to a merchant, a risk that the buyer incorrectly enters the amount of payment exists.

Currently, no efficient solution has been proposed for the above problems.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method and an apparatus of payment processing to solve at least the technical problems of a relatively efficiency of an offline transaction process caused by manual input of a payment amount that is needed for each offline payment.

In implementations, a payment processing method is provided, and includes collecting an audio signal; obtaining a graphic code, wherein the graphic code is generated based on a predetermined account and a number recognized from the audio signal, the number being used for indicating an amount to be paid and the predetermined account being an account that is to have a payment activity; and displaying the graphic code, the graphic code being used for triggering the payment activity with the predetermined account to complete a payment of the amount corresponding to the number upon being scanned.

In implementations, obtaining the graphic code may include obtaining a voiceprint in the audio signal; matching the voiceprint in the audio signal with a voiceprint corresponding to the predetermined account; and generating the graphic code based on the predetermined account and the number recognized from the audio signal if the matching is successful.

In implementations, the method may further include displaying first prompt information if the matching fails; and recollecting an audio signal for voiceprint matching or receiving inputted textual information in response to the first prompt information, wherein the textual information includes the number.

In implementations, the method may further include displaying the number recognized from the audio signal.

In implementations, the method may further include displaying second prompt information, wherein the second prompt information is used for instructing a determination of whether the number is correct; and recollecting an audio signal or receiving inputted textual information in response to determining that the number is incorrect, wherein the textual information includes the number.

In implementations, displaying the graphic code may include sending the graphic code to a server for verifying the validity of the graphic code; receiving a verification result from the server; and displaying the graphic code in response to the verification result indicating that the graphic code is valid.

In implementations, the method may further include displaying third prompt information in response to the verification result indicating that the graphic code is invalid; and recollecting an audio signal or receiving inputted textual information in response to the third prompt information, wherein the textual information includes the number.

In implementations, the obtained graphic code is generated locally or generated by a server.

In implementations, obtaining the graphic code may include determining a local network condition, and obtaining the graphic code that is generated by the server when the network condition satisfies a predetermined criterion; and obtaining the graphic code that is generated locally when the network condition does not satisfy the predetermined criterion.

In implementations, the present disclosure further provides another payment processing method, which includes scanning a graphic code to trigger making a payment of an amount corresponding to a number to a predetermined account, wherein the graphic code is generated based on the predetermined account and the number recognized from a collected audio signal; receiving a returned confirmation result, wherein the confirmation result indicating that the payment is successful or the payment fails; and displaying the confirmation result.

In implementations, if the confirmation result indicates that the payment fails, a directive command is triggered, wherein the directive command is used for instructing to re-scan the graphic code.

In implementations, the present disclosure further provides a payment processing apparatus, which includes a collection unit used for collecting an audio signal; an acquisition unit used for obtaining a graphic code, wherein the graphic code is generated based on a predetermined account and a number recognized from the audio signal, the number being used for indicating an amount to be paid and the predetermined account being an account that is to have a payment activity; and a first display unit used for displaying the graphic code, the graphic code being used for triggering the payment activity with the predetermined account to complete a payment of the amount corresponding to the number upon being scanned.

In implementations, the acquisition unit may include an acquisition module used for obtaining a voiceprint in the audio signal; a matching module used for matching the voiceprint in the audio signal with a voiceprint corresponding to the predetermined account; and a generation module used for generating the graphic code based on the predetermined account and the number recognized from the audio signal if the matching is successful.

In implementations, the apparatus may include a display module used for displaying first prompt information if the matching fails; and a collection module used for recollecting an audio signal for voiceprint matching or receiving inputted textual information in response to the first prompt information, wherein the textual information includes the number.

In implementations, the present disclosure further provides another payment processing apparatus, which may include a payment unit used for scanning a graphic code to trigger making a payment of an amount corresponding to a number to a predetermined account, wherein the graphic code is generated based on the predetermined account and the number recognized from a collected audio signal; a receiving unit used for receiving a returned confirmation result, wherein the confirmation result indicating that the payment is successful or the payment fails; and a second display unit used for displaying the confirmation result.

In implementations, the apparatus may further include a triggering unit used for triggering a directive command if the confirmation result indicates that the payment fails, wherein the directive command is used for instructing to re-scan the graphic code.

In implementations, the present disclosure further provides a transaction method, which may include collecting an audio signal; recognizing a first audio feature and transaction information from the audio signal, wherein the transaction information is used for indicating a transaction activity to occur with a first account; determining a pre-stored audio feature of the first account that matches with the first audio feature; and displaying a graphic code, wherein the graphic code is generated based at least on an account identifier of the first account and the transaction information, and the graphic code is used for triggering an occurrence of the transaction activity with the first account.

In implementations, the method may further include displaying transaction content recognized from the audio signal.

In implementations, the method may further include displaying fourth prompt information, wherein the fourth prompt information is used for instructing a determination of whether the transaction content is correct; and recollecting an audio signal or receiving an input of textual information in response to determining that the transaction content is incorrect, wherein the textual information includes the transaction content.

In implementations, the present disclosure further provides another mobile device, which may include an audio collection apparatus used for collecting an audio signal; processor(s) used for obtaining a graphic code, wherein the graphic code wherein the graphic code is generated based on a predetermined account and a number recognized from the audio signal, the number being used for indicating an amount to be paid, and the predetermined account being an account that is to have a payment activity; and a display used for displaying the graphic code, the graphic code being used for triggering the payment activity with the predetermined account to complete a payment of the amount corresponding to the number upon being scanned.

The implementations of the present disclosure generate a graphic code using an audio, and collect an audio signal; obtains graphic code, wherein the graphic code is generated based on a predetermined account and a number recognized from the audio signal, the number being used for indicating an amount to be paid and the predetermined account being an account that is to have a payment activity; and display the graphic code, the graphic code being used for triggering the payment activity with the predetermined account to complete a payment of the amount corresponding to the number upon being scanned. Thus, the goal of making a payment of an amount corresponding to a number to a predetermined account can be implemented by directly scanning a graphic code, thus achieving the technical effects of improving the efficiency of offline transaction processes, and thereby solving the technical problems of a relatively low efficiency of offline transaction processes caused by the need of manual entry of a payment account for each offline payment.

### BRIEF DESCRIPTION OF DRAWINGS

Accompanying drawings herein are used for providing a further understanding of the present disclosure, and form a part of the present disclosure. Exemplary embodiments of the present disclosure and a description thereof are used for describing the present disclosure, and are not construed as improper limitations of the present disclosure. In the accompanying drawings:

FIG. 1 is a flowchart of a payment processing method in accordance with the embodiments of the present disclosure.

FIG. 2 is a first flowchart of an optional payment processing method in accordance with the embodiments of the present disclosure.

FIG. 3 is a second flowchart of an optional payment processing method in accordance with the embodiments of the present disclosure.

FIG. 4 is a third flowchart of an optional payment processing method in accordance with the embodiments of the present disclosure.

FIG. 5 is a fourth flowchart of an optional payment processing method in accordance with the embodiments of the present disclosure.

FIG. 6 is a first schematic diagram illustrating an application scenario of an optional payment processing method in accordance with the embodiments of the present disclosure.

FIG. 7 is a second schematic diagram illustrating an application scenario of an optional payment processing method in accordance with the embodiments of the present disclosure.

FIG. 8 is a third schematic diagram illustrating an application scenario of an optional payment processing method in accordance with the embodiments of the present disclosure.

FIG. 9 is a fourth schematic diagram illustrating an application scenario of an optional payment processing method in accordance with the embodiments of the present disclosure.

FIG. 10 is a fifth schematic diagram illustrating an application scenario of an optional payment processing method in accordance with the embodiments of the present disclosure.

FIG. 11 is a sixth schematic diagram illustrating an optional payment processing method in accordance with the embodiments of the present disclosure.

FIG. 12 is a seventh schematic diagram illustrating an optional payment processing method in accordance with the embodiments of the present disclosure.

FIG. 13 is a schematic diagram of a payment processing apparatus in accordance with the embodiments of the present disclosure.

FIG. 14 is a flowchart of a transaction method in accordance with the embodiments of the present disclosure.

FIG. 16 is a schematic diagram of a mobile device in accordance with the embodiments of the present disclosure.

FIG. 17 is a block diagram of a hardware structure of a computer terminal in accordance with the embodiments of the present disclosure.

FIG. 18 is a block diagram of an optional hardware structure of a computer terminal in accordance with the embodiments of the present disclosure.

### DETAILED DESCRIPTION

In order to enable one skilled in the art to understand the solutions of the present disclosure in a better manner, the technical solutions in the embodiments of the present disclosure are described in a clear and complete manner in conjunction with the accompanying drawings in the embodiments of the present disclosure. Apparently, the described embodiments merely represent some and not all of the embodiments of the present disclosure. Based on the embodiments in the present disclosure, all other embodiments that can be obtained by one of ordinary skill in the art without making any creative effort shall fall within the scope of protection of the present disclosure.

It should be noted that terms such as “first”, “second”, etc., in the specification, claims and drawings of the present disclosure are used for distinguishing similar objects, and are not necessarily used for describing a specific order or rank. It should be understood that data that is used in such manner can be exchanged under a suitable condition, so that the embodiments of the present disclosure described herein can be implemented in an order other than those described herein or in the drawings. Furthermore, terms such as “include”, “contain”, and any variation thereof are intended to cover non-exclusive inclusion. For example, a process, method, system, product or device including a series of actions or units is not limited to actions or units that are described, and may include those that are described explicitly, or other actions or units that are inherent in the process, method, system, product or device.

First, the following explanations are suitable for nouns or terminologies appearing in the description of the embodiments of the present disclosure.

A graphic code is a specific graphic that recorded data information. Commonly seen graphic codes include a two-dimensional codes or two-dimensional barcodes. A two-dimensional barcode or two-dimensional code is used herein as an example. A two-dimensional barcode or two-dimensional code is a graphic of a specific geometrical shape that has blacks and whites distributed on a planar (two-dimensional) surface according to a certain rule and records data symbol information. The two-dimensional barcode or two-dimensional code tactfully uses the concept of a bit stream of “0” and “1” that constructs a basis of logic internal to a computer, and uses geometrical shapes corresponding to a binary system to represent textual data value information. The two-dimensional barcode or two-dimensional code can be automatically read through an image input device or optoelectronic scanning device to implement automated processing. The two-dimensional barcode or two-dimensional code possesses common characteristics of barcode technologies. Each code system has a specific a character set, and each character occupies a certain width, having a certain verification functionality, etc. Furthermore, a functionality of automatic recognition for information at different rows, and processing of a rotation change point of a graphic are also included.

An audio signal (audio) is an information carrier of a sound wave carrying voice, music and sound effect and having a pattern of change of frequency and amplitude. Based on characteristics of a sound wave, audio information can be classified into regular audio and irregular audio. The regular audio can also be classified into voice, music and sound effect. The regular audio is a continuously changing analog signal, and can be represented by a continuous curve, which is called a sound wave. Three main elements of a voice include pitch, loudness and tone. A sound wave or sinusoid wave has three important parameters, which are frequency ω0, amplitude An, and phase ψn. This determines characteristics of an audio signal.

A voiceprint is an acoustic spectrum that carries language information and is displayed by an electro-acoustic instrument.

### First Embodiment

Based on the embodiments of the present disclosure, an embodiment of a payment processing method is provided. It should be noted that operations shown in a flowchart of the accompanying drawings can be implemented in a computer system of computer-executable instructions, for example. Furthermore, although a flowchart shows a logical order, operations that are shown or described can be executed in a different order under certain conditions.

An example method provided in the first embodiment can be widely used in a payment field. For example, when a payee (e.g., a seller) and a payer (e.g., a buyer) conduct product transaction, the payee or the payer generally needs to input a payment amount if a payment application is used for conducting a mobile payment. For example, after the seller enters a monetary amount, a payment from the buyer to the seller can be completed directly by scanning a two-dimensional code provided by the buyer. For another example, after scanning a two-dimensional code of the seller, the buyer enters a monetary amount to be paid to complete a payment from the buyer to the seller. Regardless of which payment method, an action of scanning and an action of entering a monetary amount are needed. In the following embodiments, a graphic code (e.g., a two-dimensional code or two-dimensional barcode) can be generated based on a predetermined account and a number recognized from an audio signal, and a payment activity can be completed after the graphic code is scanned, thus reducing the influence of the efficiency of a transaction process due to the need of manually entering a payment amount by a payer in each offline payment. This achieves the goal of implementing a payment of a monetary amount corresponding to a number to a predetermined account by directly scanning a graphic code, and thus achieves the technical effects of improving the efficiency of a transaction process.

In the embodiments of the present disclosure, a payer terminal, a payee terminal and a server can access with each other through a network. The payer terminal and the payee terminal can be computing devices or mobile devices, such as a mobile phone, a tablet computer, a personal computer, a notebook, a VMware workstation, etc. The server can be a physical or logical server, and can be two or more than two physical or logical servers having different responsibilities and cooperating with each other to implement various functions of the server according to the embodiments of the present disclosure. The embodiments of the present disclosure do not impose any limitation on types of payer terminals, payee terminals and servers, and types of communication networks and protocols among these three, for example. The following embodiments can be considered as functions of an application in a computing device or a mobile device, or can be considered as functions included in an operating system of the computing device or the mobile device.

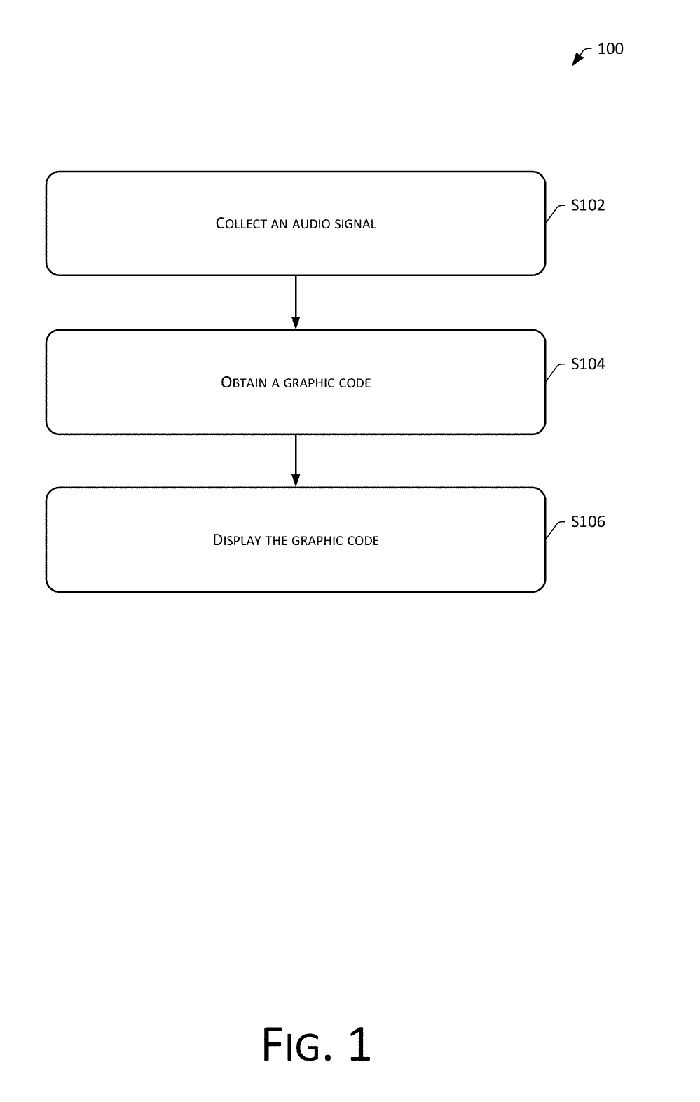

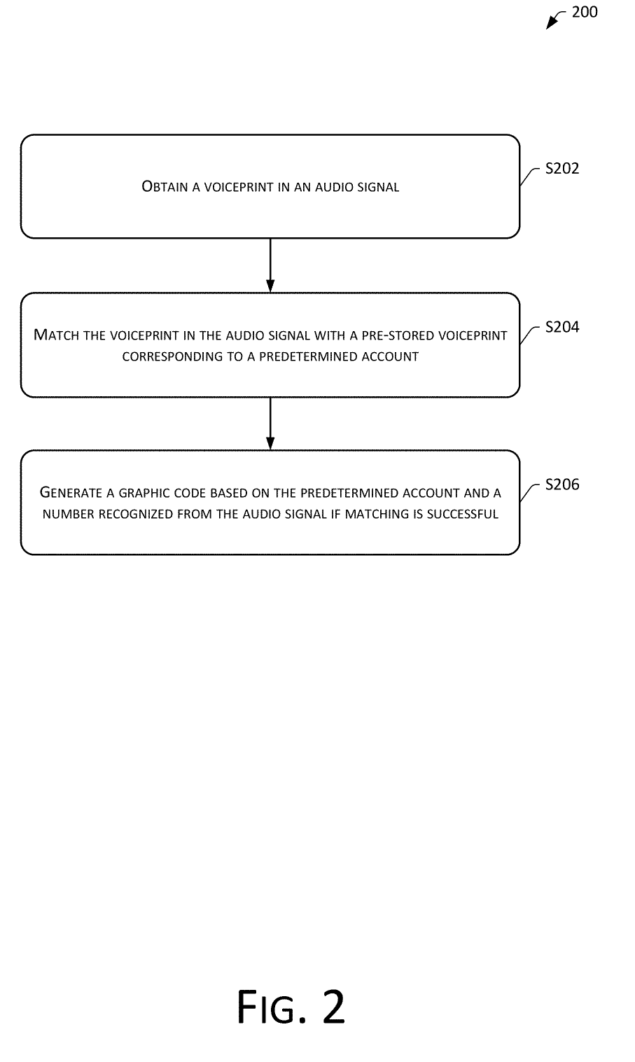

The embodiments of the present disclosure provide a payment processing method as shown in FIG. 1. Operations included in the payment processing method may be run in a computing device or a mobile device. FIG. 1 is a flowchart of a payment processing method 100 in accordance with the embodiments of the present disclosure. As shown in FIG. 1, the method 100 may include the following operations:

S102, collecting an audio signal.

An audio signal in the embodiments of the present disclosure can be an audio signal inputted by a payer or a payee. For example, a payer or a payee inputs a voice through a terminal thereof, and a payer terminal or a payee terminal receives an audio signal corresponding to this voice. It should be noted that an audio signal corresponding to this voice that is collected is an audio signal carrying a number. This number is used for indicating an amount to be paid. For example, a payee inputs a voice through a terminal thereof: “pay me 45 dollars”. An audio signal corresponding to this voice includes a number 45. For another example, a payer may input a voice through a terminal thereof: “pay 45 dollars”. An audio signal corresponding to this voice also includes 45.

S104, obtaining a graphic code, wherein the graphic code is generated based on a predetermined account and a number recognized from the audio signal, the number being used for indicating an amount to be paid, and the predetermined account being an account with which a payment activity is to be occurred.

In this operation, if a payer initiates a payment, a generated graphic code is generated based on an account of the payer and a number that is recognized from an audio signal corresponding to a voice inputted by the payer. If a payee initiates a payment, a generated graphic code is generated based on an account of the payee and a number that is recognized from an audio signal corresponding to a voice inputted by the payee. Regarding of an account of a payee or an account of a payer, they can be considered as an account with which a payment activity is to be occurred. Differences are that a payment activity of a payer is to pay out, and a payment activity of a payee is to receive.

It should be noted that voice recognition technology is a well-developed technology, but is not involved in a payment field. In the embodiments of the present disclosure, a number of different ways of recognizing numbers from audio signals corresponding to voice inputted by a payer and a payee exist. For example, only a number is recognized from a voice. Alternatively, voice inputted by a payer and a payee is converted into a text, and a number is extracted from the text. The embodiments of the present application have no limitations on the ways of ways of recognizing numbers from voice inputted by payers and payees.

S106, displaying the graphic code, wherein the graphic code is used for triggering an occurrence of the payment activity with the predetermined account to complete a payment of the amount corresponding to the number upon being scanned.

In this operation, the generated graphic code is displayed, to enable a payer or a payee to scan the graphic code and trigger a payment activity. For example, if a payee initiates a payment, a payer can complete a payment after scanning the graphic code. For another example, if a payer initiates a payment, a payee can complete a payment after scanning the graphic code.

Using the above operations, a graphic code is generated based on a number recognized from an audio signal corresponding to a voice inputted by a payer or a payee, and the graphic code is used for conducting a payment, thus achieving the goal of directly implementing a payment of an amount corresponding to a number by scanning the graphic code. This thereby achieves a technical effect of improving the efficiency of an offline transaction process, and thus solves the technical problem of a relatively low efficiency of offline transaction processes due to the need of manually inputting a payment amount in each offline payment.

In the above operations, a voice input provides convenience. However, some problems may exist under certain circumstances. For example, when a transaction party conducts a voice input, another transaction party or another person nearby carelessly speaks a number. This number may be recognized to generate a graphic code, and the graphic code carrying this number is incorrect. In implementations, voiceprint verification can be introduced for solving this problem.

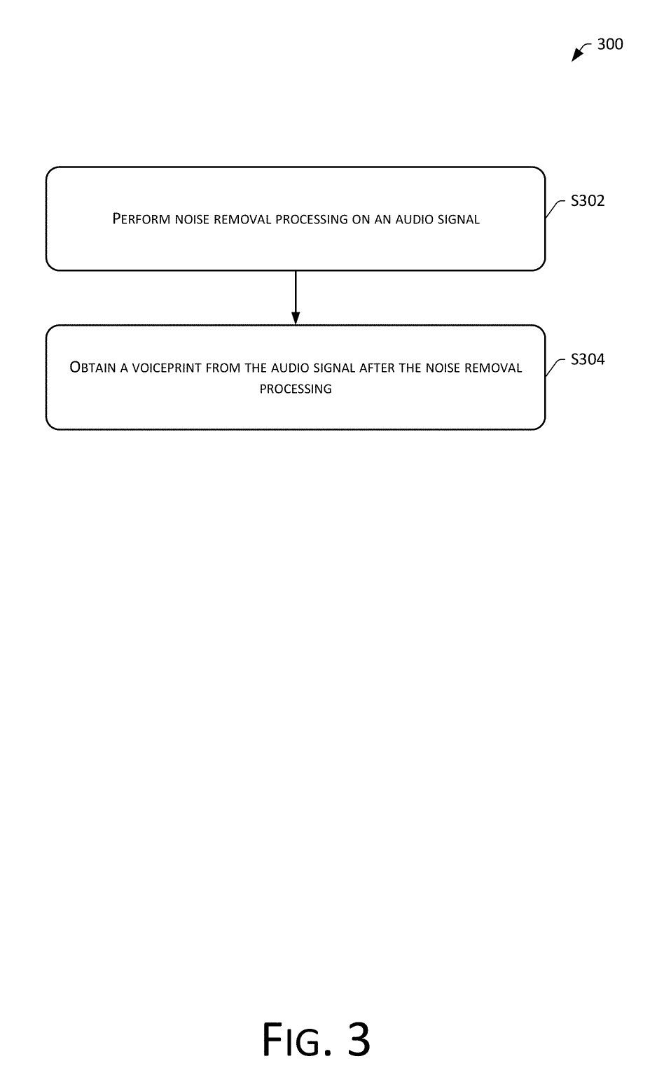

FIG. 2 shows a flowchart of generating a graphic code after voiceprint verification is introduced. As shown in FIG. 2, a method 200 thereof may include the following operations:

S202, obtaining a voiceprint in an audio signal.

A voiceprint in an audio signal is obtained. The voiceprint can be used for performing identity verification on an identified source of the audio signal.

S204, matching the voiceprint in the audio signal with a pre-stored voiceprint corresponding to a predetermined account.

In order to verify an identity of a source of the audio signal, a matching with a pre-stored voiceprint corresponding to a predetermined account is performed for the voiceprint in the audio signal.

S206, generating a graphic code based on the predetermined account and a number recognized from the audio signal if the matching is successful.

A graphic code is generated based on the predetermined account and a number recognized from the audio signal in response to a successful matching of the voiceprint in the audio signal with the pre-stored voiceprint corresponding to the predetermined account.

In implementations, if a matching between the voiceprint in the audio signal and the pre-stored voiceprint corresponding to the predetermined account fails, first prompt information is displayed. The first prompt information in the embodiments of the present disclosure can be information indicating that the matching fails, information prompting for a recollection of an audio signal, or information prompting for a textual input. In response to the first prompt information, an audio signal is recollected for voiceprint matching, or inputted textual information is received. The textual information includes a number. By recollecting an audio signal for voiceprint matching or receiving inputted textual information, a graphic code is ensured to be generated in cases when a voiceprint in an audio signal fails to match with a pre-stored voiceprint corresponding to a predetermined account.

The payment processing method provided by the embodiments of the present disclosure obtains a voiceprint in an audio signal, and matches the voiceprint in the audio signal with a pre-stored voiceprint corresponding to a predetermined account. If a matching thereof is successful, a graphic code is generated based on the predetermined account and a number that is recognized from the audio signal. Verification of an identity of a source of an audio signal ensures the security of the source of the audio signal that is collected, thus ensuring the accuracy of the graphic code that is generated based on the audio signal.

In the above operations, in order to ensure the accuracy of a graphic code that is generated, voiceprint verification is performed, and a voiceprint in an audio signal is obtained. However, under certain circumstances in which a surrounding environment has a great deal of interference of noise when a payee or a payer conducts a voice input, a large amount of noise may exist in an audio signal corresponding to a collected voice that is inputted by the payee or the payer, thus affecting the accuracy of a voiceprint obtained in the audio signal. In implementations, noise removal processing can be introduced to solve this problem.

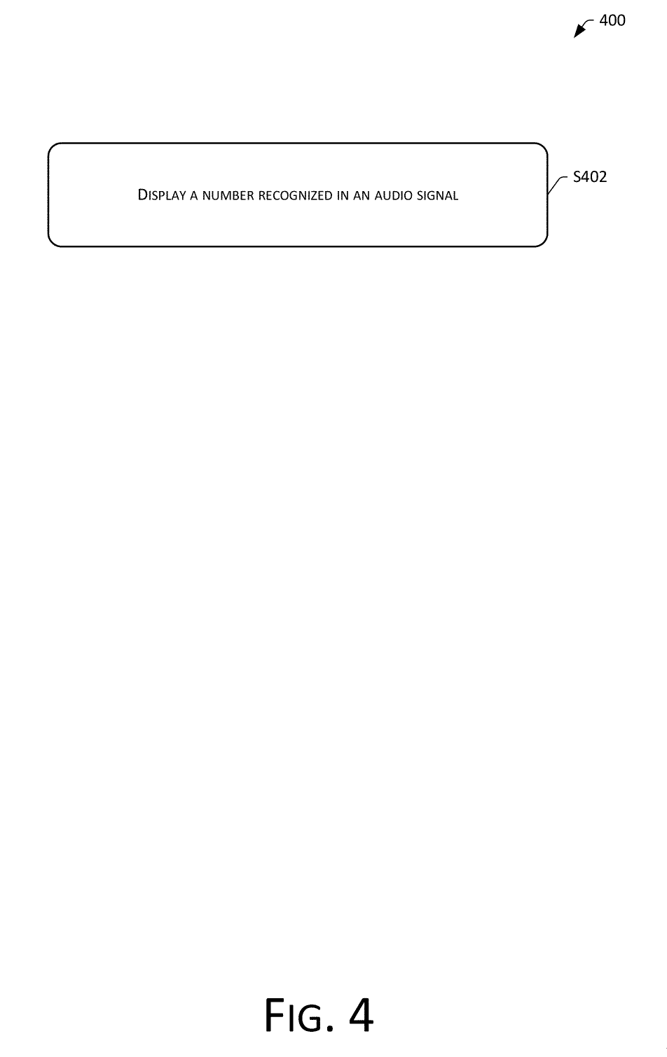

FIG. 3 shows a flowchart of obtaining a voiceprint after noise removal processing for an audio signal is introduced. As shown in FIG. 3, a method 300 thereof may include the following operations:

S302, performing noise removal processing on an audio signal.

Due to a great deal of interference of noise in a surrounding environment when a payee or a payer conducts a voice input, a large amount of noise may exist in an audio signal corresponding to a collected voice that is inputted by the payee or the payer, thus affecting the accuracy of a voiceprint that is extracted from the audio signal. Therefore, in order to ensure the accuracy of a voiceprint that is extracted from an audio signal, noise removal processing is performed on the audio signal, to remove noise from the audio signal. It should be noted that the embodiments of the present disclosure do not limit manners of removing noises from an audio signal.

S304, obtaining a voiceprint in the audio signal after the noise removal processing.

After the noise removal processing is performed, a voiceprint in the audio signal with noise removed is obtained.

Accordingly, the payment processing method provided by the embodiments of the present disclosure performs noise removal processing on an audio signal, and obtains a voiceprint from the audio signal with noise removed, thereby ensuring the accuracy of the voiceprint that is obtained from the audio signal, and ensuring the reliability of subsequent verification on the voiceprint.

In the above operations, a voice input brings about convenience. A graphic code is displayed according to a voice that is inputted, and a payer or a payee can complete an offline transaction by directly scanning the graphic code. However, some problems may exist in certain situations. For example, if a transaction party carelessly speaks a wrong number when conducting a voice input, this number is recognized to generate a graphic code. Therefore, the number carried in the graphic code is incorrect, resulting in an incorrect payment if a payer or a payee directly scans the graphic code. Accordingly, the efficiency of an offline transaction process is affected. In implementations, a display of a number recognized from an audio signal can be introduced after a graphic code is displayed to solve this problem.

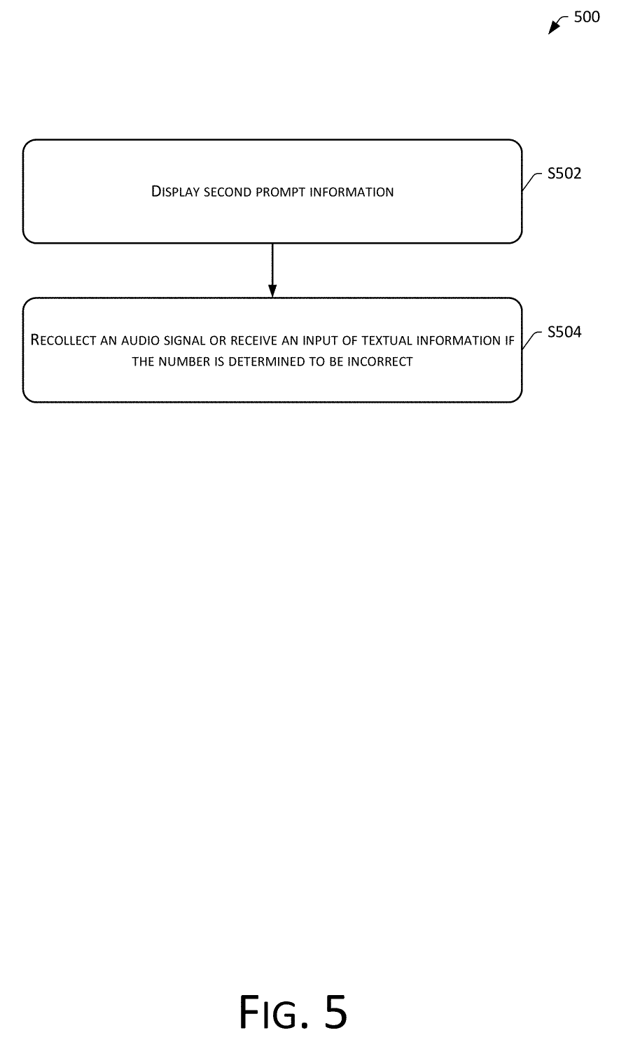

FIG. 4 shows a flowchart of displaying a number that is recognized from an audio signal. As shown in FIG. 4, a method 400 thereof may include the following operations.

S402, displaying a number recognized from an audio signal.

In order to allow a payer or a payee to determine whether a payment amount carried in a graphic code is correct before the payer or the payee directly scans the graphic code, a number recognized from the audio signal is displayed. Therefore, the payer or payee can determine whether an amount to be paid is correct intuitively through this number. For example, a payee inputs a voice into a payee terminal: “pay me 45 dollars”. A number recognized from an audio signal can be 45 dollars, or can be another number. After a graphic code is generated based on a predetermined account and a number recognized from an audio signal, the number recognized from the audio signal is displayed intuitively, thus facilitating a payer or a payee to intuitively determine with an amount to be paid is correct through this number.

It should be noted that the number recognized from the audio signal can be directly displayed on the graphic code or other positions according to the embodiments of the present disclosure, provided that a payer or a payee can intuitively determine the number at the display position. Therefore, the present disclosure does not have any limitations on a position of displaying thereof.

After the number recognized from the audio signal is displayed, two situations exist. The payer or the payee confirms that the number is the amount to be paid, i.e., confirming that the number is correct. Or, the payer or the payee determines that the number is not the amount to be paid, i.e., determining that the number is incorrect.

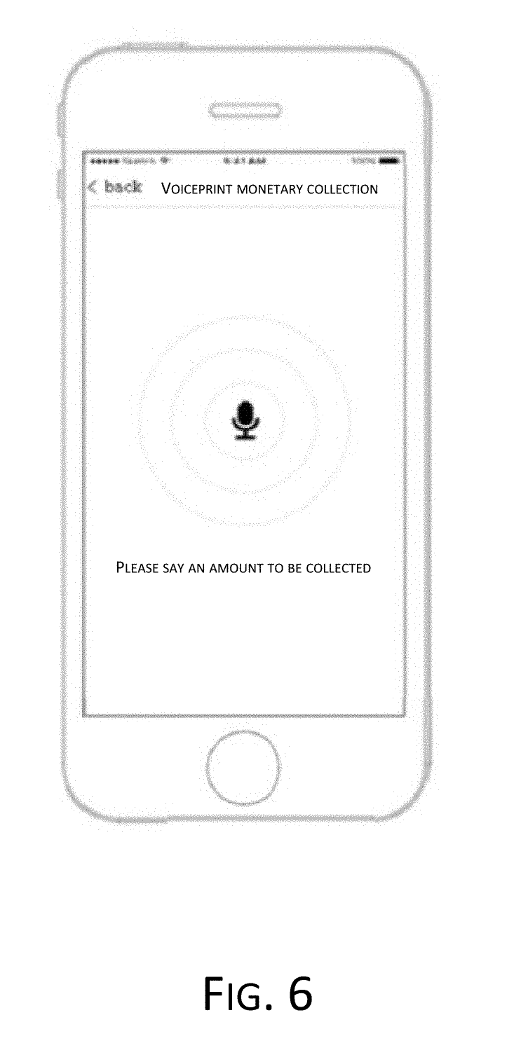

FIG. 5 shows a flowchart after a number recognized from an audio signal is displayed. As shown in FIG. 5, a method 500 thereof may include the following operations.

S502, displaying second prompt information, wherein the second prompt information is used for instructing a determination of whether a number is correct.

For another example, a payee inputs a voice into a payee terminal: “pay me 45 dollars”. A number that is recognized from an audio signal is 15 dollars. After a graphic code is generated based on a predetermined account and 15, a number 15 that is recognized from the audio signal is displayed. A payer or the payee determines that an amount to be paid is incorrect through this number, and therefore triggers a display of second prompt information, indicating a determination that the number recognized from the audio signal is incorrect.

S504, recollecting an audio signal or receive inputted textual information in response to determining that the number is incorrect, wherein the textual information includes a number.

In order to ensure the efficiency of a process of an offline transaction and to ensure that the success of the transaction, an audio signal is recollected upon determining that the number is incorrect. S104, S106 and S402 are then performed again, until a number recognized from an audio signal is confirmed to be correct. Alternatively, an input of textual information is received, wherein the textual information includes a number. When the number corresponding to the voice inputted is determined to be incorrect, textual information including a number can be directly inputted. A graphic code is thereby generated based on the inputted textual information, thus ensuring the efficiency of the process of the offline transaction and ensuring that the success of the offline transaction.

In this operation, displaying the second prompt information is to display for the payee or the payer. If the payee or the payer cannot provide confirmation information for a long time, this will affect the efficiency of the process of the offline transaction. Therefore, under this type of situation, the second prompt information is further used for instructing a determination of whether the number is correct within a predetermined time period. The inputted number is considered to be correct if confirmation information is received within the predetermined time period.

For example, the predetermined time period is 3 seconds. If confirmation information inputted by the payee or the payer is received within 3 seconds, the inputted number is considered to be correct. Therefore, the method provided by the embodiments of the present disclosure ensures the efficiency of the process of the offline transaction.

In the above operations, the voice input brings about convenience. A graphic code is displayed according to a voice that is inputted, and a payer or a payee can complete an offline transaction by directly scanning the graphic code. However, some problems may exist in certain situations. For example, a generated graphic code is not correct, or is not valid, etc. Therefore, the efficiency of the process of the offline transaction is affected. In implementations, verification of the validity of a graphic code may be introduced after the graphic code is displayed, in order to solve this problem.

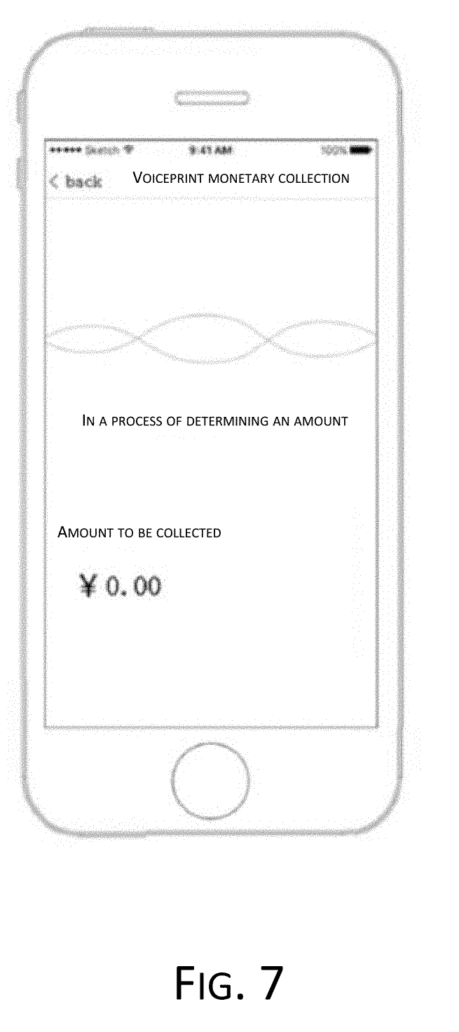

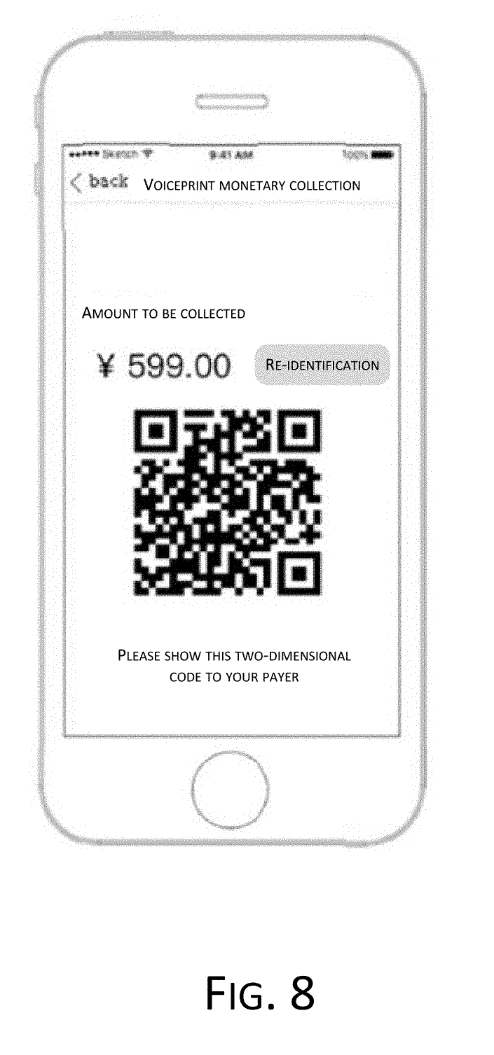

An example is shown in FIG. 6. FIG. 6 shows a mobile device collecting an audio signal inputted by a payee. After the audio signal is collected, the mobile device performs recognition on a number in the audio signal, i.e., recognizing an amount to be received that is carried in the audio signal inputted by the payee, as shown in FIG. 7. After the number (i.e., the amount) in the audio signal is recognized, a graphic code is generated based on a predetermined account and the number recognized from the audio signal. It should be noted that a graphic code in FIG. 7 is presented as a two-dimensional code. However, the embodiments of the present disclosure do not have any limitations on the graphic code. Any graphic codes from which information can be recognized are graphic codes described in the embodiments of the present disclosure.

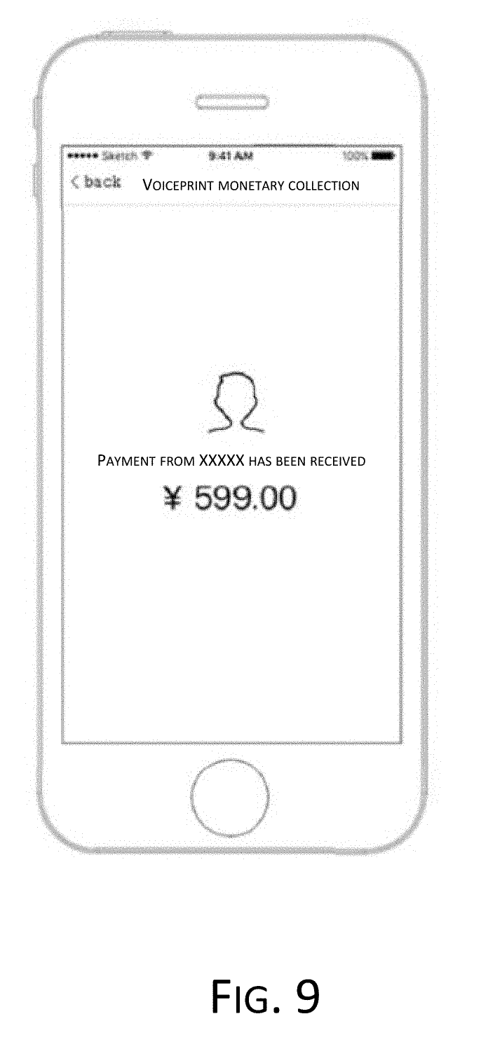

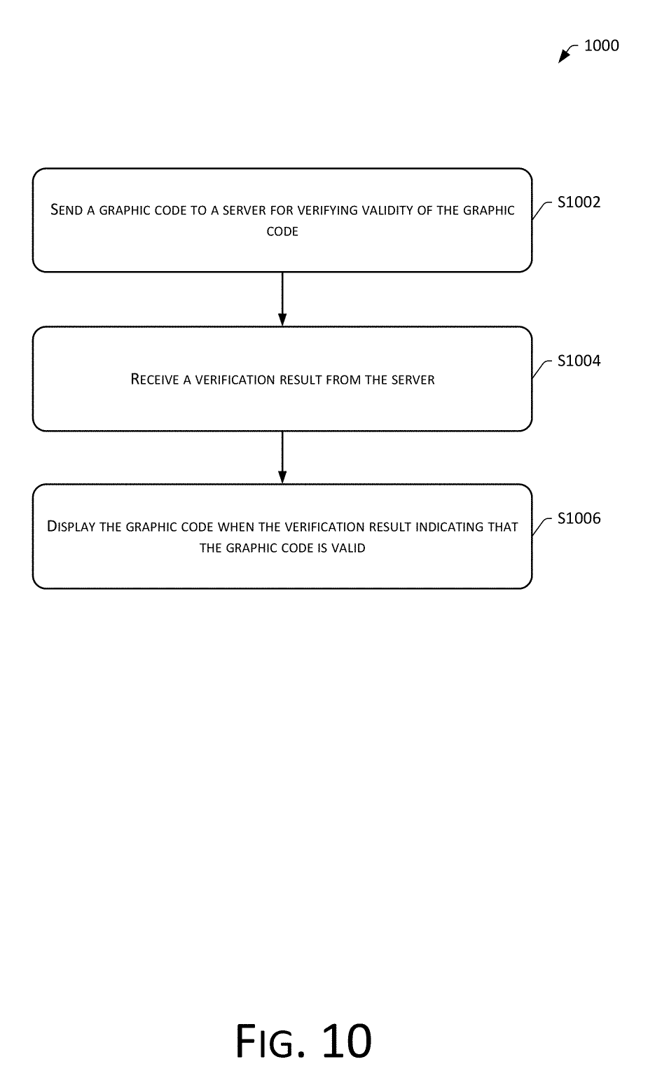

As shown in FIG. 8, the graphic code is displayed, and an amount to be received is displayed at a target position. In a situation when the amount to be received is determined to be incorrect, the payee clicks a re-identification as shown in FIG. 8, to instruct an execution of operations such as recollecting an audio signal and recognizing number (i.e., amount) information in the audio signal, until the amount to be received is confirmed to be correct. In a situation when the amount to be received is correct, the payee presents the graphic code carrying the amount to the payer, to allow the payer to scan and thus trigger an occurrence of a payment activity with the payee. FIG. 9 shows receipt information displayed in a mobile device of the payee after the payer scans the graphic code and confirms the payment. The receipt information includes an amount that is collected, and account information of the payer, etc.

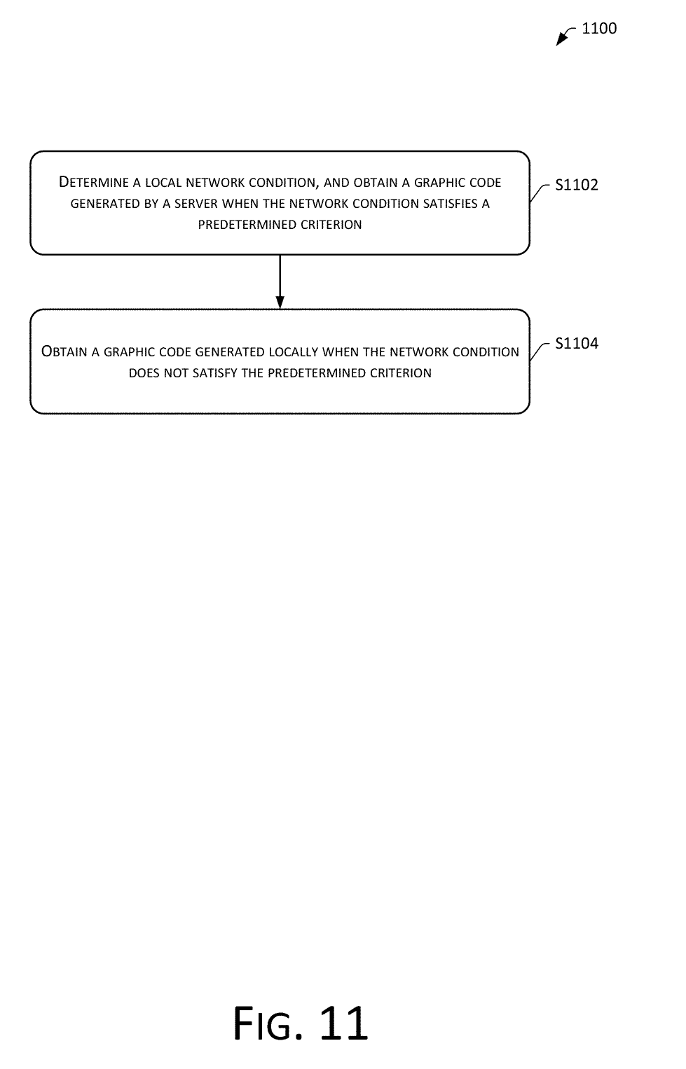

FIG. 10 shows a flowchart of performing verification on validity of a graphic code. As shown in FIG. 10, a method 1000 thereof may include the following operations:

S1002, sending a graphic code to a server for performing verification on the validity of the graphic code.

In order to perform verification on the validity of a graphic code that is generated, the graphic code is sent to a server. The validity of the graphic code is verified through analyzing or processing the generated graphic code by the server.

S1004, receiving a verification result from the server.

The server performs verification on the validity of the graphic code. After the verification is completed, the server returns a verification result. The verification result can be a result indicating that the graphic code is valid or the graphic code is invalid.

S1006, displaying the graphic code in response to the verification result indicating that the graphic code is valid.

In response to the verification result indicating that the graphic code is valid, the validity of the graphic code is confirmed. The graphic code is displayed.

Apparently, another situation may exist. In response to the verification result indicating that the graphic code is invalid, third prompt information is displayed. In response to the third prompt information, a recollection of an audio signal is performed, or an input of textual information is received, wherein the textual information includes a number.

In order to ensure the efficiency of a process of offline transaction and to ensure the success of the transaction, a recollection of an audio signal is performed in an event that the generated graphic code is determined to be invalid. The above operations are then performed again until a generated graphic code is valid. Alternatively, an input of textual information is received, wherein the textual information includes a number. In other words, when the generated graphic code is determined to be invalid, textual information including a number can be directly inputted, and a graphic code is thus generated based on the textual information that is inputted and received. Therefore, the efficiency of a process of offline transaction is ensured, and the success of the offline transaction is guaranteed.

A voice input brings about convenience. A graphic code is displayed according to the voice that is inputted, and a payer or a payee can complete an offline transaction by directly scanning the graphic code. However, if the speed of generating a graphic code based on a predetermined account and a number recognized from an audio signal is relatively slow and a waiting time of a payer or a payee for the graphic code is relatively long, the user experience is affected. In order to ensure the speed of generating a graphic code based on a predetermined account and a number recognized from an audio signal, the embodiments of the present disclosure allow the graphic code based on the predetermined account and the number recognized from the audio signal to be generated locally or generated by a server. Nevertheless, whether to generate a graphic code locally or by a server needs to be determined based on specific network conditions.

FIG. 11 shows a flowchart of selecting a terminal for generating a graphic code based on network condition(s). A method 1100 thereof may include the following operations:

S1102, determining a local network condition, and obtains a graphic code generated by a server in response to the network condition satisfying a predetermined criterion.

In general, the processing and analyzing capabilities of a server are better than a local machine. In the embodiments of the present disclosure, when a local network condition satisfies a predetermined criterion, an audio signal that is collected is sent to a server to improve the speed of generating a graphic code. The server generates a graphic code based on a predetermined account and a number recognized from the audio signal, and sends the graphic code that is generated by the server to a local machine, thus ensuring the speed of generating the graphic code.

S1104, obtaining a graphic code that is locally generated in response to the network condition failing to satisfy the predetermined criterion.

In an event that the network condition fails to satisfy the predetermined criterion, a graphic code is generated locally. A number is locally recognized from the collected audio signal, and a graphic code is generated locally based on this data and a predetermined account, thus ensuring the speed of generating the graphic code.

It should be noted that the foregoing method embodiments are represented by a series of combination of actions for the sake of description. However, one skilled in the art should understand that the present disclosure is not limited to an order of actions as described. It is because certain operations can adopt other orders or can be performed in parallel in accordance with the present disclosure. Furthermore, one skilled in the art should also understand that the embodiments described in the present disclosure are exemplary embodiments. Actions and modules involved therein are not necessarily needed by the present disclosure.

As can be seen from the above description of the embodiments, one skilled in the art can clearly understand that the above example methods can be implemented using software with necessary universal hardware platform. Apparently, hardware components can be used, but the former is more preferred way of implementation in many situations. Based on this understanding, the essence of the technical solutions of the present disclosure or the portions that provide contributions to the existing technologies can be implemented in a form of a software product. The computer software product can be stored in a storage media (such as ROM/RAM, a magnetic disk, an optical drive, etc.), which includes instructions to cause a terminal device (which may be a mobile phone, a computer, a server, or a network device, etc.) to perform the method described in various embodiments of the present disclosure.

### Second Embodiment

According to the embodiments of the present disclosure, another implementation of a payment processing method is also provided. It should be noted that operations shown in a flowchart of the accompanying drawings can be implemented in a computer system of computer-executable instructions, for example. Furthermore, although a flowchart shows a logical order, operations that are shown or described can be executed in a different order under certain conditions.

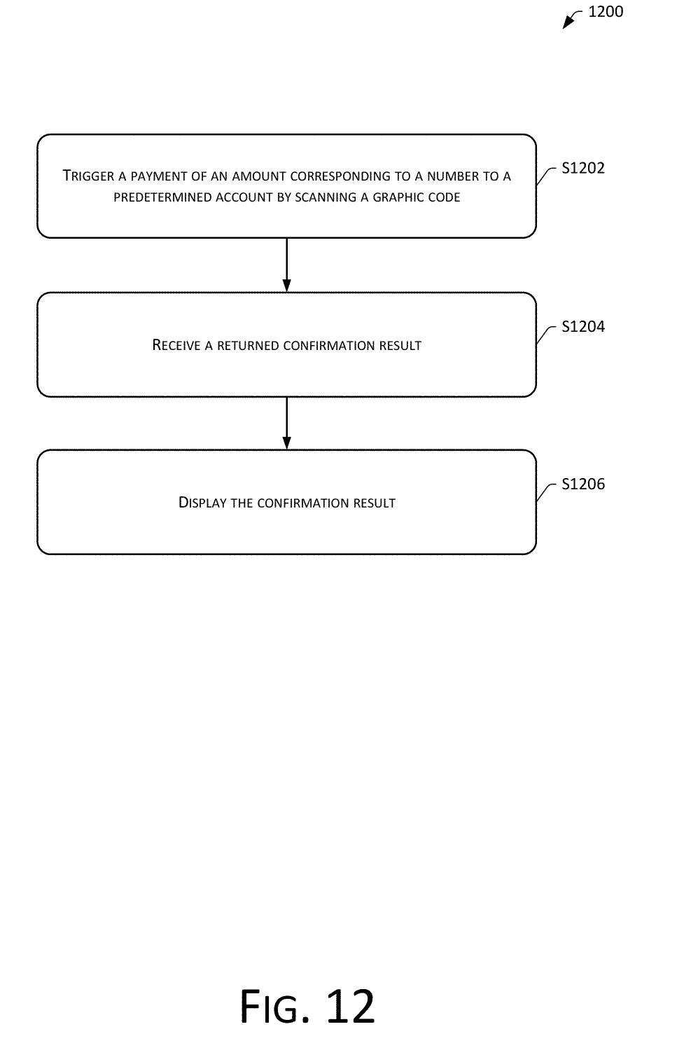

The embodiments of the present disclosure provide a payment processing method 1200 as shown in FIG. 12. As shown in FIG. 12, the method 1200 may include the following operations:

S1202, triggering a payment of an amount corresponding to a number to a predetermined account by scanning a graphic code, wherein the graphic code is generated based on the predetermined account and the number recognized from an audio signal that is collected.

S1204, receiving a returned confirmation result, wherein the confirmation result indicating that the payment is successful or the payment has failed.

S1206, displaying the confirmation result.

In the payment processing method provided by the embodiments of the present disclosure, a payment of an amount corresponding to a number to a predetermined account is triggered by scanning a graphic code. A confirmation result is received from a server, and the confirmation result is displayed. This achieves the goal of implementing a payment of an amount corresponding to a number to a predetermined account is triggered by directly scanning a graphic code, thus achieving a technical effect of improving the efficiency of an offline transaction process and solving the technical problem of a relatively low efficiency of the offline transaction process caused by the need of manual input of a payment amount in each offline payment.

In implementations, if the confirmation result indicates that the payment has failed, a directive command is triggered, wherein the directive command is used for instructing a re-scanning of a graphic code.

For example, if the server determines that the payment to the predetermined account has failed after the graphic code is scanned, a directive command is triggered to instruct the payer or the payee to re-scan the graphic code that is generated based on the predetermined account and the number recognized from the audio signal, thereby ensuring to perform a new attempt of making a payment to the predetermined account when the server determines that the payment has failed.

### Third Embodiment

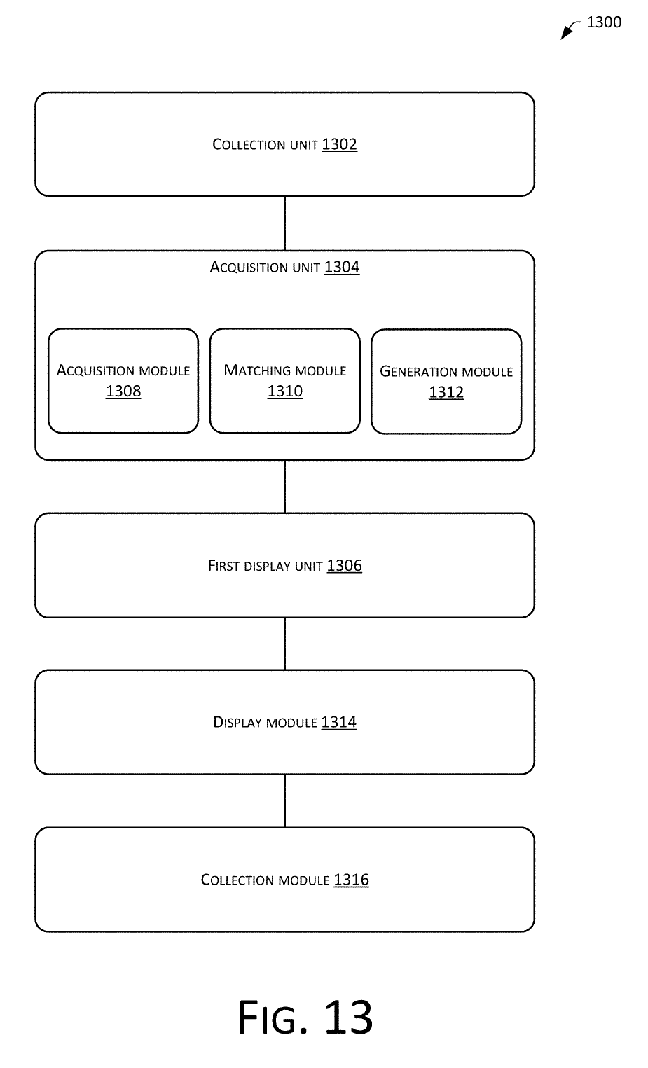

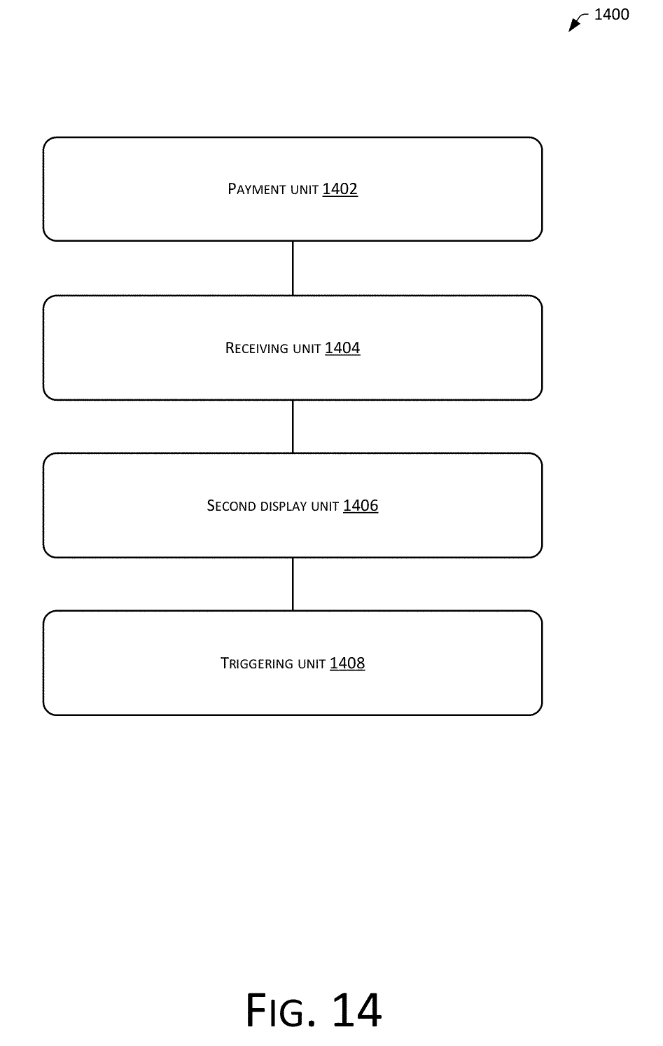

According to the embodiments of the present disclosure, an apparatus used for implementing the above payment processing method is also provided. FIG. 13 is a schematic diagram of a payment processing apparatus 1300 in accordance with the embodiments of the present disclosure. As shown in FIG. 13, the apparatus 1300 may include a collection unit 1302, an acquisition unit 1304, and a first display unit 1306.

The collection unit 1302 is used for collecting an audio signal.

An audio signal in the embodiments of the present disclosure can be an audio signal inputted by a payer or a payee. For example, a payer or a payee inputs a voice through a terminal thereof, and a payer terminal or a payee terminal receives an audio signal corresponding to this voice. It should be noted that an audio signal that corresponds to this voice and is collected by the collection unit 1302 is an audio signal carrying a number. This number is used for indicating an amount to be paid. For example, a payee inputs a voice through a terminal thereof: “pay me 45 dollars”. An audio signal corresponding to this voice includes a number 45. For another example, a payer may input a voice through a terminal thereof: “pay 45 dollars”. An audio signal corresponding to this voice also includes 45.

The acquisition unit 1304 is used for obtaining a graphic code, wherein the graphic code is generated based on a predetermined account and a number recognized from the audio signal, the number being used for indicating an amount to be paid, and the predetermined account being an account with which a payment activity is to be occurred.

If a payer initiates a payment, a graphic code that is obtained by the acquisition unit 1304 is generated based on an account of the payer and a number that is recognized from an audio signal corresponding to a voice inputted by the payer. If a payee initiates a payment, a generated graphic code is generated based on an account of the payee and a number that is recognized from an audio signal corresponding to a voice inputted by the payee. Regarding of an account of a payee or an account of a payer, they can be considered as an account with which a payment activity is to be occurred. Differences are that a payment activity of a payer is to pay out, and a payment activity of a payee is to receive.

The first display unit 1306 is used for displaying the graphic code, wherein the graphic code is used for triggering a payment of an amount corresponding to the number to the predetermined account upon being scanned.

The first display unit 1306 displays the graphic code that is obtained, to enable a payer or a payee to scan the graphic code and thus to trigger a payment activity. For example, if a payee initiates a payment, a payer can complete a payment after scanning the graphic code. For another example, if a payer initiates a payment, a payee can complete a payment after scanning the graphic code.

Using the above units, a graphic code is generated based on a number recognized from an audio signal corresponding to a voice inputted by a payer or a payee, and the graphic code is used for conducting a payment, thus achieving the goal of directly implementing a payment of an amount corresponding to a number by scanning the graphic code. This thereby achieves a technical effect of improving the efficiency of an offline transaction process, and thus solves the technical problem of a relatively low efficiency of offline transaction processes due to the need of manually inputting a payment amount in each offline payment.

For the above units, a voice input provides convenience. However, some problems may exist under certain circumstances. For example, when a transaction party conducts a voice input, another transaction party or another person nearby carelessly speaks a number. This number may be recognized to generate a graphic code, and the graphic code carrying this number is incorrect. In implementations, voiceprint verification can be introduced for solving this problem.

In the payment processing apparatus 1300 provided by the embodiments of the present disclosure, the acquisition unit 1304 may include an acquisition module 1308 used for obtaining a voiceprint in the audio signal; a matching module 1310 used for matching the voiceprint in the audio signal with a pre-stored voiceprint corresponding to the predetermined account; and a generation module 1312 used for generating the graphic code based on the predetermined account and the number recognized from the audio signal if the matching is successful.

The acquisition module 1308 obtains a voiceprint in the audio signal. The voiceprint may be used for performing identity verification on an identified source of the audio signal. In order to verify an identity of a source of the audio signal, the matching module 1310 matches the voiceprint in the audio signal with a pre-stored voiceprint corresponding to the predetermined account. The generation module 1312 generates the graphic code based on the predetermined account and the number recognized from the audio signal in response to a successful matching of the voiceprint in the audio signal with the pre-stored voiceprint corresponding to the predetermined account.

The payment processing apparatus provided by the embodiments of the present disclosure obtains a voiceprint in an audio signal, and matches the voiceprint in the audio signal with a pre-stored voiceprint corresponding to a predetermined account. If a matching thereof is successful, a graphic code is generated based on the predetermined account and a number that is recognized from the audio signal. Verification of an identity of a source of an audio signal ensures the security of the source of the audio signal that is collected, thus ensuring the accuracy of the graphic code that is generated based on the audio signal.

In implementations, the apparatus 1300 may further include a display module 1314 used for displaying first prompt information if the matching fails; and a collection module 1316 used for recollecting an audio signal for voiceprint matching or receiving an input of textual information in response to the first prompt information, wherein the textual information includes the number.

In implementations, if a matching between the voiceprint in the audio signal and the pre-stored voiceprint corresponding to the predetermined account fails, the display module 1314 displays first prompt information. The first prompt information in the embodiments of the present disclosure can be information indicating that the matching fails, information prompting for a recollection of an audio signal, or information prompting for a textual input. In response to the first prompt information, the collection module 1316 recollects an audio signal for voiceprint matching, or receives an input of textual information. The textual information includes the number. By recollecting an audio signal for voiceprint matching or receiving an input of textual information, a graphic code is ensured to be generated in cases when a voiceprint in an audio signal fails to match with a pre-stored voiceprint corresponding to a predetermined account.

The payment processing apparatus provided by the embodiments of the present disclosure obtains a voiceprint in an audio signal, and matches the voiceprint in the audio signal with a pre-stored voiceprint corresponding to a predetermined account. If a matching thereof is successful, a graphic code is generated based on the predetermined account and a number that is recognized from the audio signal. Verification of an identity of a source of an audio signal ensures the security of the source of the audio signal that is collected, thus ensuring the accuracy of the graphic code that is generated based on the audio signal.

### Fourth Embodiment

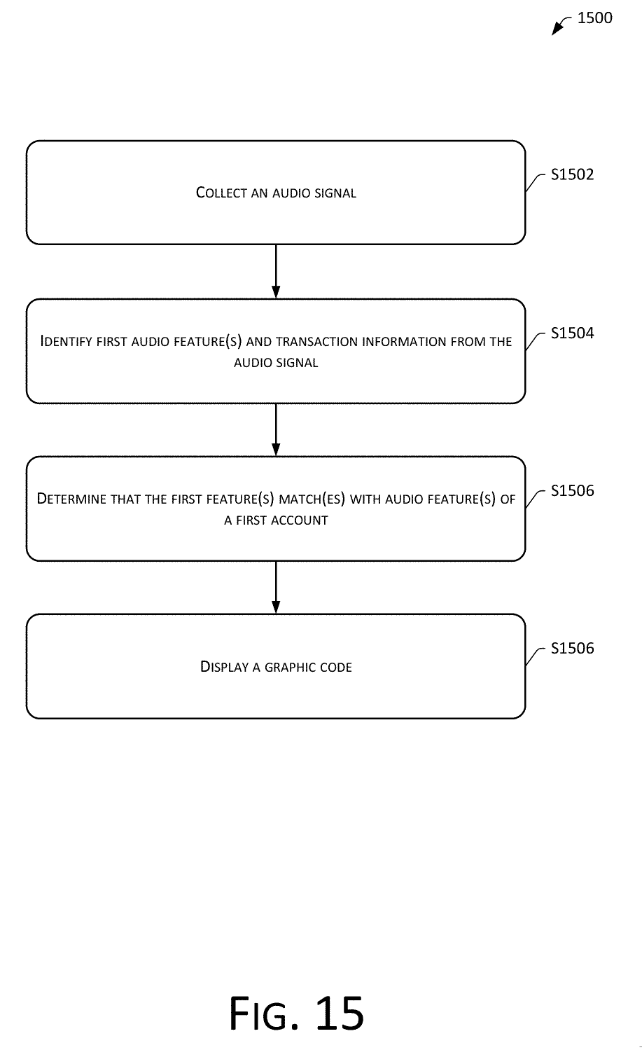

According to the embodiments of the present disclosure, an apparatus used for implementing the above payment processing method is also provided. FIG. 14 is a schematic diagram of a payment processing apparatus 1400 in accordance with the embodiments of the present disclosure. As shown in FIG. 14, the apparatus 1400 may include a payment unit 1402, a receiving unit 1404, and a second display unit 1406.

The payment unit 1402 is used for triggering a payment of an amount corresponding to a number to a predetermined account by scanning a graphic code, wherein the graphic code is generated based on the predetermined account and the number recognized from an audio signal that is collected.

The receiving unit 1404 is used for receiving a returned confirmation result, wherein the confirmation result indicating that the payment is successful or the payment has failed.

The second display unit 1406 is used for displaying the confirmation result.

In the payment processing apparatus provided by the embodiments of the present disclosure, the payment unit 1402 triggers a payment of an amount corresponding to a number to a predetermined account by scanning a graphic code. The receiving unit 1404 receives a confirmation result from a server, and the second display unit 1406 displays the confirmation result. This achieves the goal of implementing a payment of an amount corresponding to a number to a predetermined account is triggered by directly scanning a graphic code, thus achieving a technical effect of improving the efficiency of an offline transaction process and solving the technical problem of a relatively low efficiency of the offline transaction process caused by the need of manual input of a payment amount in each offline payment.

In implementations, if the confirmation result indicates that the payment has failed, a triggering unit 1408 triggers a directive command, wherein the directive command is used for instructing a re-scanning of a graphic code.

For example, if the server determines that the payment to the predetermined account has failed after the graphic code is scanned, the triggering unit 1408 triggers a directive command to instruct a payer or a payee to re-scan the graphic code that is generated based on the predetermined account and the number recognized from the audio signal, thereby ensuring to perform a new attempt of making a payment to the predetermined account when the server determines that the payment has failed.

### Fifth Embodiment

According to the embodiments of the present disclosure, another implementation of a payment processing method is also provided. It should be noted that operations shown in a flowchart of the accompanying drawings can be implemented in a computer system of computer-executable instructions, for example. Furthermore, although a flowchart shows a logical order, operations that are shown or described can be executed in a different order under certain conditions.

The embodiments of the present disclosure provide a transaction method 1500 as shown in FIG. 15. As shown in FIG. 15, operations included in the transaction method 1500 may be run in a computing device and a mobile device. The method 1500 may include the following operations:

S1502, collecting an audio signal.

S1504, identifying first audio feature(s) and transaction information from the audio signal, wherein the transaction information is used for indicating an occurrence of a transaction activity with a first account.

S1506, determining that the first audio feature(s) match(es) with pre-stored audio feature(s) of the first account.

S1508, displaying a graphic code, wherein the graphic code is generated based at least on an account identifier of the first account and the transaction information, and the graphic code is used for triggering the occurrence of the transaction activity with the first account.

For example, when conducting a transaction, a transaction party A inputs an audio signal in a mobile device, with the audio signal being “generate an order for product A”. After collecting the audio signal, information such as audio features and the order for the product A is identified. The identified audio features are then matched with pre-stored audio features associated with an account of the transaction party A. In response to determining that the matching is successful, a graphic code is generated based on an account identifier of the account of the transaction party A and the order for the product A. The graphic code is also displayed. After a transaction party B scans the graphic code, an occurrence of a transaction activity between the transaction party B and the transaction party A is triggered. In response to a confirmation of the transaction party B for conducting the transaction, the transaction activity with the transaction party A is completed.

Through the above operations, an implementation of a transaction activity with a predetermined account by directly scanning a graphic code can be achieved, thus implementing a technical effect of improving the efficiency of a process of offline transaction, and solving the technical problem of a relatively low efficiency of the process of offline transaction due to the need of manual input of transaction content in each offline transaction.

In order to enable a transaction party to intuitively determine whether transaction content inputted by voice is correct and to ensure the accuracy of a graphic code that is subsequently generated, the transaction method in the embodiments of the present disclosure may further include displaying transaction content recognized from the audio signal. Therefore, a transaction party can intuitively determine the accuracy of the transaction content inputted through voice.

In an event that a transaction party can intuitively determine the accuracy of transaction content inputted through voice, the transaction method in the embodiments of the present disclosure may further include displaying fourth prompt information, wherein the fourth prompt information is used for instructing a determination of whether the transaction content is correct. In an event that the transaction content is incorrect, a recollection of an audio signal is performed, or an input of textual information is received, wherein the textual information includes the transaction content.

In an event that a transaction party determines that the transaction content inputted through voice is incorrect, a recollection of an audio signal is performed, and operations such as identifying audio feature(s) and transaction content in the audio signal, until transaction content is determined to be correct. Alternatively, an input of textual information including the transaction content is directly received. A graphic code is generated based on the received textual information and an account of a transaction party. This thereby achieves an implementation of a transaction activity with a predetermined account by directly scanning a graphic code, and thus implements a technical effect of improving the efficiency of a process of offline transaction.

### Sixth Embodiment

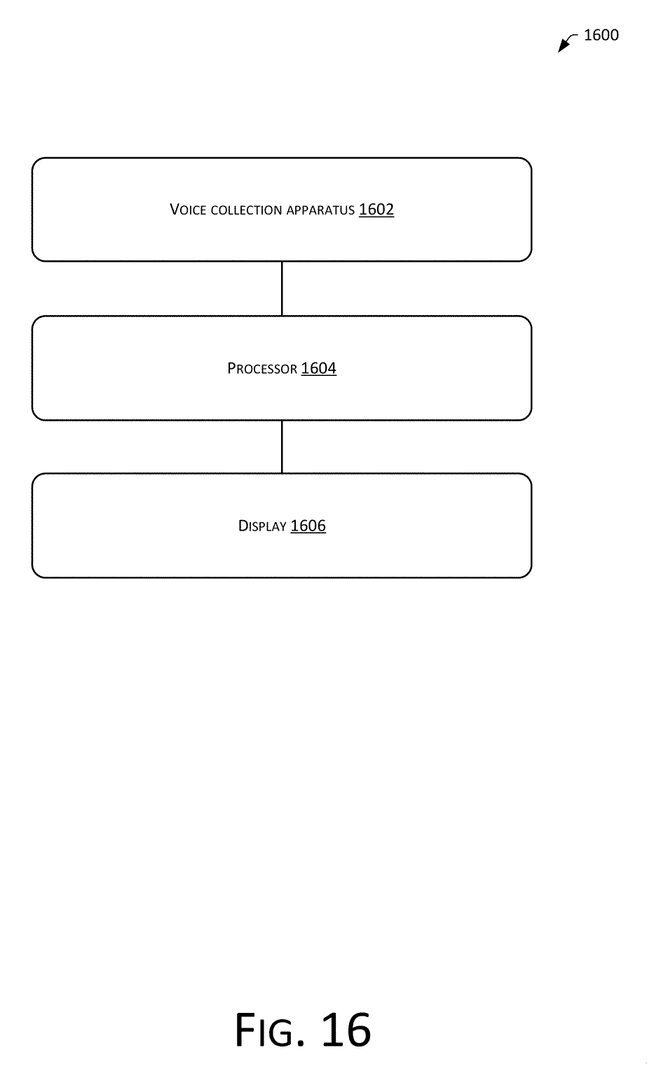

According to the embodiments of the present disclosure, a mobile device is also provided. FIG. 16 is a schematic diagram of a mobile device 1600 in accordance with the embodiments of the present disclosure. As shown in FIG. 16, the mobile device 1600 may include a voice collection apparatus 1602 used for collecting an audio signal; processor(s) 1604 used for obtaining a graphic code, wherein the graphic code wherein the graphic code is generated based on a predetermined account and a number recognized from the audio signal, the number being used for indicating an amount to be paid and the predetermined account being an account that is to have a payment activity; and a display 1606 used for displaying the graphic code, the graphic code being used for triggering the payment activity with the predetermined account to complete a payment of the amount corresponding to the number upon being scanned.

The mobile device in the embodiments of the present disclosure can be a mobile phone, IPAD, etc. The embodiments of the present disclosure do not have any limitations thereon.

The mobile device in the embodiments of the present disclosure collects an audio signal through the audio collection apparatus 1502; the processor(s) 1604 used for obtaining a graphic code, wherein the graphic code wherein the graphic code is generated based on a predetermined account and a number recognized from the audio signal, the number being used for indicating an amount to be paid, and the predetermined account being an account that is to have a payment activity; and a display 1606 used for displaying the graphic code, the graphic code being used for triggering the payment activity with the predetermined account to complete a payment of the amount corresponding to the number upon being scanned. This achieves the goal of implementing a payment of an amount corresponding to a number to a predetermined account is triggered by directly scanning a graphic code, thus achieving a technical effect of improving the efficiency of an offline transaction process and solving the technical problem of a relatively low efficiency of the offline transaction process caused by the need of manual input of a payment amount in each offline payment.

### Seventh Embodiment

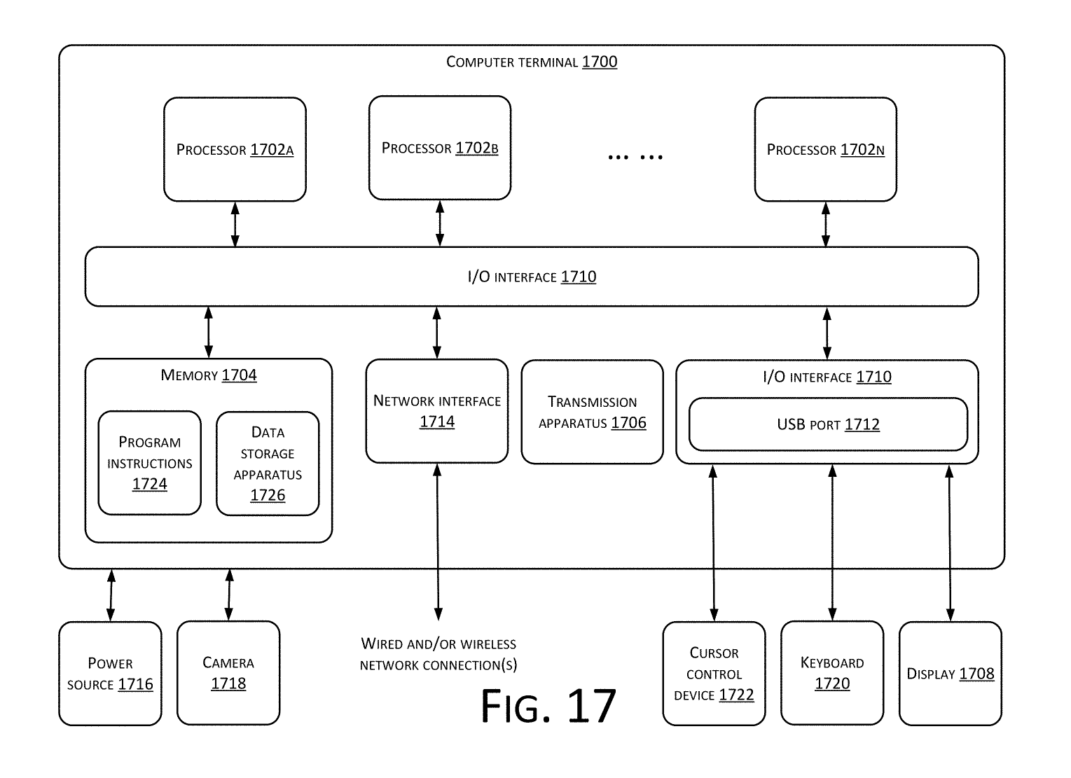

The example payment processing methods provided in the embodiments of the present disclosure can be implemented in a mobile device, a computer terminal, or a similar computing apparatus. FIG. 17 shows a block diagram of a hardware structure of a computer terminal 1700 that is used for implementing a payment processing method. In implementations, each of the foregoing apparatuses, such as apparatuses 1300 and 1400, may include one or more computer terminals 1700, or may be a part of the one or more computer terminals 1700. In implementations, each of the apparatuses 1300 and 1400 may be located in a single computer terminal 1700, or may be distributed among a plurality of computer terminals 1700 over a network, such as a cloud computing architecture.

As shown in FIG. 17, the computer terminal 1700 (or mobile device 1700) may include one or more processors 1702 (which are shown as 1702a, 1702b, . . . , 1702n in the figure) (the processors 1702 may include, but are not limited to, a processing device such as a microprocessor (MCU) or a programmable logic device (FPGA), etc.), memory 1704 used for storing data, and a transmission apparatus 1706 used for performing communications. Besides, the computer terminal 1700 may also include a display 1708, an input/output (I/O) interface 1710, a universal serial bus (USB) port 1712 (which can be included as one of the ports in the I/O interface), a network interface 1714, a power source 1716, and/or a camera 1718. In implementations, the computer terminal 1700 may further have accessory devices such as a keyboard 1720, and a cursor control device 1722, for example. One of ordinary skill in the art can understand that the structure shown in FIG. 17 is merely illustrative, which does not impose any limitations on a structure of the above electronic device. For example, the computer terminal 1700 may also include more or fewer components as shown in FIG. 17, or include a configuration different from that shown in FIG. 17.

It should be noted that the one or more processors 1702 and/or other data processing circuits can generally be called as “data processing circuits” in the present specification. The data processing circuits can be implemented partly or entirely in a form of software, hardware, or any other combination thereof. Furthermore, the data processing circuits can be an independent processing module, or can be partly or entirely combined into any one of other components in the computer terminal 1700 (or mobile device). As involved in the embodiments of the present disclosure, the data processing circuits are treated as a type of processor control (e.g., selecting a variable resistance of a termination path connected to an interface).

The memory 1704 may be used for storing software programs and modules of application software, such as program instructions 1724/data storage apparatus 1726 corresponding to the payment processing methods in the embodiments of the present disclosure. The processors 1702 execute various functional applications and data processing by running software program(s) and module(s) stored in the memory 1704, thus implementing the above payment processing methods. The memory 1704 may include high-speed random access memory, and may also include non-volatile memory such as one or more magnetic storage devices, flash memory, or other non-volatile solid state memory. In some embodiments, the memory 1704 may further include storage devices that are deployed remotely from the processors 1702. These remote storage devices can connect to the computer terminal 1700 through a network. Examples of the network include, but are not limited to, the Internet, an intranet, a local area network, a mobile communication network, and a combination thereof.

In implementations, the memory 1704 may include a form of computer readable media such as a volatile memory, a random access memory (RAM) and/or a non-volatile memory, for example, a read-only memory (ROM) or a flash RAM. The memory 1704 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The transmission apparatus 1706 is used for receiving or sending data through a network. An example of the network may include a wireless network provided by a communication provider of the computer terminal 1700. In an example, the transmission apparatus 1706 may include a network interface controller (NIC), which can conduct communications with the Internet by connecting to a base station or other network devices. In an example, the transmission apparatus 1706 may be a radio frequency (RF) module, which is used for conducting communications with the Internet through a wireless means.

The display 1708 may be a touch-screen liquid crystal display (LCD). The liquid crystal display can allow a user to interact with a user interface of the computer terminal 1700 (or mobile device).

It should be noted herein that the computer terminal 1700 (or mobile device) as shown in FIG. 17 may include hardware components (e.g., electrical circuits), software components (including computer codes that are stored in computer readable media), or a combination of hardware components and software components in some alternative embodiments. It should be noted that FIG. 17 is merely an exemplary embodiment with the purpose of illustrating types of components that may exist in the above computer terminal (or mobile device).

The embodiments of the present disclosure can provide a type of a computer terminal. The computer terminal can be any computer terminal device in a cluster of computer terminals. In implementations, the above computer terminal may also be replaced by a terminal device such as a mobile device.

In implementations, the above computer terminal may be located in at least one network device of a plurality of network devices in a computer network.

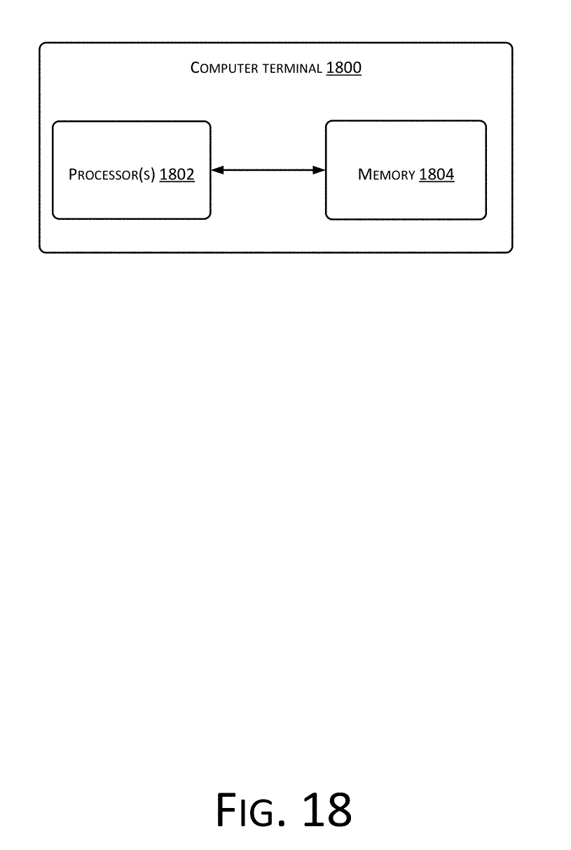

FIG. 18 is a block diagram of a structure of an alternative computer terminal in accordance with the embodiments of the present disclosure. As shown in FIG. 18, the computer terminal 1800 may include one or more (only one being shown in the figure) processors 1802 and memory 1804.

The memory 1804 may be used for storing software programs and modules of application software, such as program instructions/data storage apparatuses corresponding to the payment processing methods in the embodiments of the present disclosure. The processors 1802 execute various functional applications and data processing by running software program(s) and module(s) stored in the memory 1804, thus implementing the above payment processing methods. The memory 1804 may include high-speed random access memory, and may also include non-volatile memory such as one or more magnetic storage devices, flash memory, or other non-volatile solid state memory. In some embodiments, the memory 1804 may further include storage devices that are deployed remotely from the processors 1802. These remote storage devices can connect to the computer terminal 1800 through a network. Examples of the network include, but are not limited to, the Internet, an intranet, a local area network, a mobile communication network, and a combination thereof.

The processors 1802 can execute the following operations by invoking information and application program(s) stored in the memory 1804 through a transmission apparatus 1806: collecting an audio signal; obtaining a graphic code, wherein the graphic code is generated based on a predetermined account and a number recognized from the audio signal, the number being used for indicating an amount to be paid, and the predetermined account being an account that is to have a payment activity; and displaying the graphic code, the graphic code being used for triggering the payment activity with the predetermined account to complete a payment of the amount corresponding to the number upon being scanned.

In implementations, the processors 1802 may also execute program codes of the following operations: obtaining a voiceprint in the audio signal; matching the voiceprint in the audio signal with a voiceprint corresponding to the predetermined account; and generating the graphic code based on the predetermined account and the number recognized from the audio signal if the matching is successful.

In implementations, the processors 1802 may also execute program codes of the following operations: collecting an audio signal; obtaining a graphic code, wherein the graphic code is generated based on a predetermined account and a number recognized from the audio signal, the number being used for indicating an amount paid to the predetermined account; and displaying the graphic code, wherein the graphic code is used for triggering a payment of the amount corresponding to the number to the predetermined account.

In implementations, the processors 1802 may also execute program codes of the following operations: displaying first prompt information if the matching has failed; and recollecting an audio signal for voice matching or receiving an input of textual information in response to the first prompt information, wherein the textual information includes the number.

In implementations, the processors 1802 may also execute program codes of the following operations: performing noise removal processing on the audio signal; and obtaining a voiceprint from the audio signal after the noise removal processing.

In implementations, the processors 1802 may also execute program codes of the following operations: displaying second prompt information, wherein the second prompt information is used for instructing a determination of whether the number is correct; and recollecting an audio signal or receiving an input of textual information in response to determining that the number is incorrect, wherein the textual information includes the number.

In implementations, the processors 1802 may also execute program codes of the following operation: determining that the number inputted is correct when confirmation information is received within a predetermined time period, wherein the second prompt information is used for instructing the determination of whether the number is correct within the predetermined time period.

In implementations, the processors 1802 may also execute program codes of the following operations: sending the graphic code to a server for verifying the validity of the graphic code; receiving a verification result from the server; and displaying the graphic code when the verification result indicating that the graphic code is valid.

In implementations, the processors 1802 may also execute program codes of the following operations: displaying third prompt information when the verification result indicating that the graphic code is invalid; and recollecting an audio signal or receiving an input of textual information in response to the third prompt information, wherein the textual information includes the number.

In implementations, the processors 1802 may also execute program codes of the following operation: obtaining the graphic code that is generated locally or generated by a server.

In implementations, the processors 1802 may also execute program codes of the following operations: determining a local network condition; and obtaining a graphic code generated by a server when the network condition satisfies a predetermined criterion, or obtaining a graphic code generated locally when the network condition fails to satisfy the predetermined criterion.

The embodiments of the present disclosure provide a solution for a computer terminal used for implementing a payment processing method through collecting an audio signal. An audio signal is collected. A graphic code is obtained, wherein the graphic code is generated based on a predetermined account and a number recognized from the audio signal, the number is used for indicating an amount to be paid, and the predetermined account is an account with which a payment activity is to be happened; and displaying the graphic code, wherein the graphic code is used for triggering a payment of the amount corresponding to the number to the predetermined account. The present disclosure solves the technical problem of a relatively low efficiency of an offline transaction process caused by the need of manual input of a payment amount in each offline payment.

One of ordinary skill in the art can understand that some or all of the operations of various methods of the foregoing embodiments can be completed through instructing hardware components related to a terminal device by a program. The program can be stored in computer readable storage media. The storage media may include a flash drive, read-only memory (ROM), random access memory (RAM), a magnetic disk, or an optical drive, etc.

### Eighth Embodiment

The embodiments of the present disclosure further provide a storage media. In implementations, the storage media may be used for storing program codes that are executed by the payment processing method provided in the first embodiment.

In implementations, the storage media may be located in any computer terminal in a cluster of computer terminals in a computer network, or located in any mobile device of a cluster of mobile devices.

In implementations, the storage media is configured to store program codes that are used for performing the following operations: collecting an audio signal; obtaining a graphic code, wherein the graphic code is generated based on a predetermined account and a number recognized from the audio signal, the number being used for indicating an amount to be paid, and the predetermined account being an account that is to have a payment activity; and displaying the graphic code, the graphic code being used for triggering the payment activity with the predetermined account to complete a payment of the amount corresponding to the number upon being scanned.

In implementations, storage media is configured to store program codes that are used for performing the following operations: obtaining a voiceprint in the audio signal; matching the voiceprint in the audio signal with a voiceprint corresponding to the predetermined account; and generating the graphic code based on the predetermined account and the number recognized from the audio signal if the matching is successful.

In implementations, storage media is configured to store program codes that are used for performing the following operations: displaying first prompt information if the matching has failed; and recollecting an audio signal for voice matching or receiving an input of textual information in response to the first prompt information, wherein the textual information includes the number.

In implementations, storage media is configured to store program codes that are used for performing the following operations: performing noise removal processing on the audio signal; and obtaining a voiceprint from the audio signal after the noise removal processing.

In implementations, storage media is configured to store program codes that are used for performing the following operations: displaying the number recognized from the audio signal; displaying second prompt information, wherein the second prompt information is used for instructing a determination of whether the number is correct; and recollecting an audio signal or receiving an input of textual information in response to determining that the number is incorrect, wherein the textual information includes the number.

In implementations, storage media is configured to store program codes that are used for performing the following operation: determining that the number inputted is correct when confirmation information is received within a predetermined time period, wherein the second prompt information is used for instructing the determination of whether the number is correct within the predetermined time period.

In implementations, storage media is configured to store program codes that are used for performing the following operations: sending the graphic code to a server for verifying the validity of the graphic code; receiving a verification result from the server; and displaying the graphic code when the verification result indicating that the graphic code is valid.

In implementations, storage media is configured to store program codes that are used for performing the following operations: displaying third prompt information when the verification result indicating that the graphic code is invalid; and recollecting an audio signal or receiving an input of textual information in response to the third prompt information, wherein the textual information includes the number.

In implementations, storage media is configured to store program codes that are used for performing the following operation: obtaining the graphic code that is generated locally or generated by a server.

In implementations, storage media is configured to store program codes that are used for performing the following operations: determining a local network condition; and obtaining a graphic code generated by a server when the network condition satisfies a predetermined criterion, or obtaining a graphic code generated locally when the network condition fails to satisfy the predetermined criterion.

Sequence numbers of the above embodiments of the present disclosure are merely used for description, and do not represent the qualities of the embodiments.

In the embodiments of the present disclosure, the embodiments are described with different emphases. Related description of other embodiments can be referenced for a part of a certain embodiment that is not described in detail.

In the embodiments of the present disclosure, it can be understood that the disclosed technical content can be implemented through other approaches. The above apparatus embodiments are merely illustrative. For example, a division of the units is merely a division of logical functionalities. In a real implementation, other way of division may exist. For example, a plurality of units or components can be combined or integrated into another system. Alternatively, some features may be ignored, or may not be executed. Moreover, mutual coupling, direct coupling, or communication connection that is described or discussed can be made through indirect coupling or communication connection between some interfaces, units, or modules, and may be in an electrical or other form.

Units that are described as separate components may or may not be physical separate. A component which is presented as a unit may or may not be a physical unit, i.e., may be located in a single place, or may be distributed among a plurality of network units. Some or all of the units may be selected for implementing the goal of the solutions of the embodiments according to an actual need.

Furthermore, various units in each embodiment of the present disclosure can be integrated into a single processing unit. Alternatively, each unit may exist as an independent physical entity. Alternatively, two or more than two units may be integrated into a single unit. The above integrated unit may be implemented in a form of hardware, or may be implemented in a form of a software functional unit.

If the integrated unit is implemented in a form of a software functional unit and is sold or used as an independent product, the integrated unit can be stored in a computer readable storage media. Based on this understanding, the essence of the technical solutions of the present disclosure, the portions that provide contributions to the existing technologies, or some of all of the technical solutions can be implemented in a form of a software product. The computer software product can be stored in a storage media, which includes instructions to cause a computing device (which may be a personal computer, a server, or a network device, etc.) to perform some or all of the operations of the method described in each embodiment of the present disclosure. The storage media includes various types of media that are able to store program codes, such as a universal disk, read-only memory (ROM), random access memory (RAM), a movable hard disc, a magnetic disk, or an optical disc, etc.

Exemplary embodiments of the present disclosure are described above. It should be noted that one of ordinary skill in the art can make improvements and polishing without departing the principles of the present disclosure. These improvements and polishing should fall within the scope of protection of the present disclosure.

What is claimed is:

1. A method implemented by a computing device, the method comprising:
collecting an audio signal;
obtaining a graphic code, wherein the graphic code is generated based on a predetermined account and a number recognized from the audio signal, the number being used for indicating an amount to be paid and the predetermined account being an account that is to have a payment activity; and
displaying the graphic code, wherein the graphic code is used for triggering the payment activity with the predetermined account to complete a payment of the amount corresponding to the number upon being scanned.

2. The method of claim 1, wherein obtaining the graphic code comprises:
obtaining a voiceprint in the audio signal;
matching the voiceprint in the audio signal with a voiceprint corresponding to the predetermined account; and
generating the graphic code based on the predetermined account and the number recognized from the audio signal if the matching is successful.

3. The method of claim 2, further comprising:
displaying first prompt information if the matching fails; and
recollecting a new audio signal for voiceprint matching or receiving inputted textual information in response to the first prompt information, wherein the textual information includes the number.

4. The method of claim 2, further comprising performing noise removal processing on the audio signal prior to obtaining the voiceprint in the audio signal.

5. The method of claim 1, further comprising displaying the number recognized from the audio signal.

6. The method of claim 5, further comprising:
displaying second prompt information, wherein the second prompt information is used for instructing a determination of whether the number is correct; and
recollecting a new audio signal or receiving inputted textual information in response to determining that the number is incorrect, wherein the textual information includes the number.

7. The method of claim 6, wherein the second prompt information is used for instructing the determination of whether the number is correct within a predetermined time period, and the number is determined to be correct when confirmation information is received within the predetermined time period.

8. The method of claim 1, wherein displaying the graphic code comprises:
sending the graphic code to a server for verifying a validity of the graphic code;
receiving a verification result from the server; and
displaying the graphic code in response to the verification result indicating that the graphic code is valid.

9. The method of claim 8, further comprising:
displaying third prompt information in response to the verification result indicating that the graphic code is invalid; and
recollecting a new audio signal or receiving inputted textual information in response to the third prompt information, wherein the textual information includes the number.

10. The method of claim 1, wherein the graphic code is generated locally or generated by a server.

11. The method of claim 10, wherein obtaining the graphic code comprises:
determining a local network condition; and
obtaining the graphic code that is generated by the server when the network condition satisfies a predetermined criterion, or obtaining the graphic code that is generated locally when the network condition does not satisfy the predetermined criterion.

12. The method of claim 1, further comprising:
receiving a returned confirmation result, wherein the confirmation result indicating that the payment is successful or the payment fails; and
displaying the confirmation result.

13. The method of claim 12, further comprising triggering a directive command when the confirmation result indicates that the payment has failed, wherein the directive command is used for instructing that a re-scanning of the graphic code is needed.

14. One or more computer readable media storing executable instructions that, when executed by one or more processors, cause the one or more processors to perform acts comprising:
scanning a graphic code to trigger making a payment of an amount corresponding to a number to a predetermined account, wherein the graphic code is generated based on the predetermined account and the number recognized from a collected audio signal;
receiving a returned confirmation result, wherein the confirmation result indicating that the payment is successful or the payment fails; and
displaying the confirmation result.

15. The one or more computer readable media of claim 14, the acts further comprising triggering a directive command when the confirmation result indicates that the payment has failed, wherein the directive command is used for instructing to re-scan the graphic code.

16. A system comprising:
one or more processors;
memory storing executable instructions that, when executed by the one or more processors, cause the one or more processors to perform acts comprising:
collecting an audio signal;
recognizing a first audio feature and transaction information from the audio signal, wherein the transaction information is used for indicating a transaction activity to occur with a first account;
determining a pre-stored audio feature of the first account that matches with the first audio feature; and
displaying a graphic code, wherein the graphic code is generated based at least on an account identifier of the first account and the transaction information

17. The system of claim 16, wherein the graphic code is further used for triggering an occurrence of the transaction activity with the first account.

18. The system of claim 16, the acts further comprising displaying transaction content recognized from the audio signal.

19. The system of claim 18, the acts further comprising displaying prompt information, wherein the prompt information is used for instructing a determination of whether the transaction content is correct.

20. The system of claim 19, the acts further comprising collecting a new audio signal or receiving an input of textual information in response to determining that the transaction content is incorrect, wherein the textual information includes the transaction content.
